(19) United States
(12) Patent Application Publication
(10) Pub. No.: US 2007/0012569 A1
(43) Pub. Date: Jan. 18, 2007

(54) Cationic electrodeposition coating composition

(76) Inventors: Yasuo Mihara, Osaka (JP); Takefumi Yamamoto, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/448,716

(22) Filed: Jun. 8, 2006

(30) Foreign Application Priority Data
Jun. 8, 2005 (JP) 2005-168580

(51) Int. Cl. C09D 5/44

(52) U.S. Cl. 204/499

(57) ABSTRACT

A cationic electrodeposition coating composition having superior defoaming property and being capable of effectively preventing the generation of unevennes of drying is provided. A cationic electrodeposition coating composition comprising a binder resin containing a cationic epoxy resin and a block isocyanate curing agent and a defoaming agent, wherein the defoaming agent contains at least one of polyoxyalkylene compounds (A) represented by any one of the following formulae (1) to (3):
]R—(OA)ₙ₁]ₜ₋ₘQ[—(OA)ₙ₂-L]ₘ (1)
[R—(OA)ₙ₁]ₜ₋ₘQ[—(OA)ₙ₂-L-(OA)ₙ₃-Q[—(OA)ₙ₄-R]_{t-1]}ₘ (2)
[R—(OA)ₙ₁]ₜ₋₁Q-L-Q [—(OA)ₙ₂-L]ₜ₋₁ (3) wherein Q is a reaction residual group formed by removing a hydrogen atom(s) from a number t of primary hydroxyl groups of nonreducing disaccharide or trisaccharide, L is the reaction residual group of isocyanate or the reaction residual group of dihalogenated alkyl, OA is an oxyalkylene group having a carbon number of 2 to 4, each of n1 to n4 is independently an integer of 2 to 40, t is an integer of 2 to 4 and m is an integer of 1 to 3 and smaller than t, but provided that the total number of OA's in a molecule is 10 to 80 per one of Q.

### FIELD OF THE INVENTION

The present invention relates to a cationic electrodeposition coating composition comprising a defoaming agent and specifically, relates to a cationic electrodeposition coating composition comprising a defoaming agent with a specific structure, and the like.

### BACKGROUND OF THE INVENTION

Cationic electrodeposition coating is carried out by immersing a coated article as cathode in an electrodeposition bath containing a cationic electrodeposition coating composition and applying voltage. The cationic electrodeposition coating composition filled in the electrodeposition bath is dispersion containing aqueous medium, a binder resin dispersed in the aqueous medium, a pigment and various additives. Accordingly, it is required to be always fluidized for keeping the uniformity of the paint.

For example, in the electrodeposition coating step of the car body of an automobile, the cationic electrodeposition coating composition is filled in a large scale electrodeposition bath to be stirred. An uncoated car body is inserted into the one end of the electrodeposition bath, immersed in the cationic electrodeposition coating over a fixed time and then pulled out. The step is continuously carried out by line facilities. The cationic electrodeposition coating is severely fluidized in the electrodeposition bath during the step.

When the uncoated car body is immersed in the paint in such state, a large amount of foams is generated at that time. When coating is carried out while the foams generated adhere on uncoated car body, the defects of coating called as foam trace are generated.

Consequently, the electrodeposition coating composition is preferably superior in defoaming property so that foams generated in the electrodeposition coating composition at the coating step are disappeared as fast as possible. Further, various surfactants have been conventionally used as a defoaming agent for improving the defoaming property of the electrodeposition coating composition.

For example, Japanese Patent Kokoku Publication No. 45196/1994 describes surfactants for a cationic electrodeposition coating comprising polypropylene glycol with a molecular weight of 500 to 1500. Further, Japanese Patent Kokoku Publication No. 45772/1994 describes a compound obtained by alkylating both terminals of polyether. However, these surfactants are inadequate in the defoaming property and when an amount foams generated is much, problems have been generated.

Acetylene glycol of Air Products Japan Inc. is described in a surfactant for an aqueous paint “SURFYNOL” in “Coating & Paint (Toso to Toryo)” August 2000 (No.607) page 77 edited by Ichiro Yamasaki and published by Toryo Shuppansha Co., Ltd. However, since acetylene glycol and surfactants described in the patent literatures are low in solubility and dispersibility in water, there is fear of badly affecting the stability of paint with time.

Japanese Patent Kokoku Publication No. 339364/2004 describes a cationic electrodeposition coating composition containing a defoaming agent which is a surfactant containing a polyoxyalkylene compound having a specific structure. The polyoxyalkylene compound is superior in defoaming property and very useful. On the other hand, when a coated article is pulled out of a paint bath after. cationic electrodeposition coating and rinsing is not immediately carried out, unevennes of drying is occasionally generated. The generation of the unevennes of drying lowers the appearance of electrodeposition coating. Although the cationic electrodeposition coating composition described in Patent Literature 3 was superior in the defoaming property, it could not adequately prevent the unevennes of drying of the electrodeposition coating.

### OBJECTS OF THE INVENTION

The present invention solves the above-mentioned conventional problems and it is the purpose of the present invention to provide a cationic electrodeposition coating composition having superior defoaming property and being capable of effectively preventing the generation of the unevennes of drying.

### SUMMARY OF THE INVENTION

The present invention provides a cationic electrodeposition coating composition comprising a binder resin containing a cationic epoxy resin and a block isocyanate curing agent and a defoaming agent, wherein the defoaming agent contains at least one of polyoxyalkylene compounds (A) represented by any one of the following formulae (1) to (3):
]R—(OA)ₙ₁]ₜ₋ₘQ[—(OA)ₙ₂-L]ₘ (1)
[R—(OA)ₙ₁]ₜ₋ₘQ[—(OA)ₙ₂-L-(OA)ₙ₃-Q[—(OA)ₙ₄-R]_{t-1]}ₘ (2)
[R—(OA)ₙ₁]ₜ₋₁Q-L-Q [—(OA)ₙ₂-L]ₜ₋₁ (3)
wherein Q is a reaction residual group formed by removing a hydrogen atom from a number t of primary hydroxyl groups of nonreducing disaccharide or trisaccharide,
L is the reaction residual group of isocyanate or the reaction residual group of dihalogenated alkyl,
OA is an oxyalkylene group having a carbon number of 2 to 4,
each of n1 to n4 is independently an integer of 2 to 40,
t is an integer of 2 to 4 and
m is an integer of 1 to 3 and smaller than t, but provided that the total number of OA's in a molecule is 10 to 80 per one of the number of the Q, and thereby the above-mentioned purpose is attained.

The above-mentioned Q is preferably a reaction residual group formed by removing a hydrogen atom from the 3 primary hydroxyl groups of sucrose.

Further, a coupling number per one molecule of the polyoxyalkylene compounds (A) is preferably 1.5 to 5.

The above-mentioned polyoxyalkylene compounds (A) can be produced, for example, by the chemical reaction of 1 part by mol of nonreducing disaccharide or trisaccharide (a1), 10 to 80 parts by mol of alkylene oxide having a carbon number of 2 to 4 (a2) and 0.1 to 0.8 parts by mol of isocyanate (a3-1).

Further, for example, the above-mentioned polyoxyalkylene compounds (A) can be produced by the chemical reaction of 1 part by mol of nonreducing disaccharide or trisaccharide (a1), 10 to 80 parts by mol of alkylene oxide having a carbon number of 2 to 4 (a2) and 0.2 to 0.9 parts by mol of dihalogenated hydrocarbon having a carbon number of 1 to 4 (a3-21).

Further, the content of the above-mentioned polyoxyalkylene compounds (A) is preferably 0.1 to 5 parts by weight based on 100 parts by weight of the cationic electrodeposition coating composition.

Further, the present invention provides a method for suppressing the foaming of an electrodeposition bath, comprising a step of containing a defoaming agent containing at least one of the polyoxyalkylene compounds (A) represented by any one of the above-mentioned formulae (1) to (3) so as to be 0.1 to 5 parts by weight based on 100 parts by weight of the cationic electrodeposition coating composition, in the cationic electrodeposition coating composition comprising a binder resin containing a cationic epoxy resin and a block isocyanate curing agent.

The cationic electrodeposition coating composition of the present invention is a superior composition exhibiting the superior defoaming property and being capable of effectively preventing the generation of the unevennes of drying. Further, in the present specification, performance capable of effectively preventing unevennes of drying is occasionally abbreviated as the “unevennes of drying preventing performance” or “unevennes of drying property”.

### DETAILED DESCRIPTION OF THE PREFERRED EMBODIMENTS

Defoaming Agent

The defoaming agent contained in the electrodeposition coating composition of the present invention contains the polyoxyalkylene compound (A) represented by any one of the above-mentioned general formulae (1) to (3). The reaction residual group Q in the above-mentioned general formulae (1) to (3) is a reaction residual group formed by removing a hydrogen atom(s) from a number m of primary hydroxyl groups of nonreducing disaccharide or trisaccharide. Further, a secondary hydroxyl group is not participated in the reaction and seems to be contained in the reaction residual group as it is. The nonreducing disaccharide can be used without limitation so far as it is nonreducing disaccharide and includes sucrose, isosucrose, trehalose, isotrehalose and the like. Further, the nonreducing trisaccharide can be used without limitation so far as it is nonreducing trisaccharide and includes gentianose, raffinose, melezitose, planteose and the like. Among these, sucrose, trehalose, gentianose, raffinose, and planteose are preferable from the viewpoint of surface active performance (in particular, the ability of lowering surface tension), sucrose and trehalose are more preferable and sucrose is preferable in particular from the viewpoint of supply and cost.

In the general formulae (1) to (3), the oxyalkylene group (OA) includes oxyethylene, oxypropylene, oxybutylene and a mixture thereof, etc. Among these, oxypropylene and oxybutylene are preferable from the viewpoint of the water resistance of coating and the like and oxypropylene is further preferable. Further, a number n of the OA's may be the same or different. The order (block, random and a combination thereof) of the oxyalkylene group in the OA's is not specifically limited. Further, when the OA contains an oxyethylene group, an oxypropylene group or/and an oxybutylene group, it is preferable that oxypropylene or/and oxybutylene is situated at an end portion separated from the reaction residual group (Q). Namely, when the OA contains an oxyethylene group, it is preferable that the oxyethylene group is directly bonded with the reaction residual group (Q). Further, when the OA contains a plural number of kinds of oxyalkylene groups, it is preferable that the block shape is contained. Further, when the OA contains oxyethylene, the content is preferably 30% by weight or less based on the weight of the oxyalkylene group.

In the general formulae (1) to (3), the total number of OA's in a molecule is preferably 10 to 80 per one of Q, more preferably 12 to 75, further preferably 15 to 70 and particularly preferably 18 to 65. When it is within the range, the defoaming property and unevennes of drying tend to be further better. Further, each of n1 to n4 represents an integer of 2 to 40, preferably 3 to 38, further preferably 4 to 35 and particularly preferably 5 to 30. When it is within the range, the defoaming property and unevennes of drying of coating tend to be further better. Further, each of n1 to n4 may be the same or different.

R represents a hydrogen atom, an alkyl group having a carbon number of 1 to 3 or an alkenyl group having a carbon number of 3. The alkyl group having a carbon number of 1 to 3 includes a methyl group, an ethyl group, an n-propyl group and an isopropyl group. The alkenyl group having a carbon number of 3 includes a 1-propenyl group and a 2-propenyl group. R is preferably a hydrogen atom, a methyl group, an ethyl group, an iso-propenyl group or a 2-propenyl group and R is more preferably a hydrogen atom, a methyl group or an ethyl group. The R contained in the polyoxyalkylene compound (A) of the present invention may each represent the same group or a different group.

These preferable R's are dependent on the structure of L described specifically below. For example, when the L is the reaction residual group of isocyanate, the R is most preferably a hydrogen atom. Further, for example, when the L is the reaction residual group of dihalogenated alkyl, the R is most preferably a methyl group or an ethyl group. Further, when the L is the reaction residual group of dihalogenated alkyl, there is also possibility that a halogen atom derived from the reaction of the dihalogenated S alkyl remains partially in the R and the polyoxyalkylene compound (A) of the present invention does not exclude the mode.

In the general formulae (1) to (3), m is an integer of 1 to 3 and smaller than t, preferably 1 or 2 and more preferably 1. When m is within the range, the defoaming property and the unevennes of drying preventing performance become further better.

In the general formulae (1) to (3), t is an integer of 2 to 4, preferably 2 or 3 and further preferably 2. When t is within the range, the defoaming property and the unevennes of drying preventing performance become further better.

The L is the reaction residual group of isocyanate or the reaction residual group of dihalogenated alkyl. Namely, the polyoxyalkylene compound (A) represented by the general formulae (1) to (3) has a coupling structure by the reaction residual group of isocyanate or the reaction residual group of dihalogenated alkyl. Further, the polyoxyalkylene compound having 2 or more of the Q's in a molecule is obtained according to the coupling structure. The superior defoaming property can be obtained by containing the polyoxyalkylene compound (A) as the defoaming agent contained in the electrodeposition coating composition of the present invention. In general, when a usual defoaming agent is used, the defoaming property is improved by increasing its amount, but the unevennes of drying property is lowered inversely. However, the present polyoxyalkylene compound (A) has a superior advantage that both of the defoaming property and the unevennes of drying can be improved differing from a conventional defoaming agent.

Further, the polyoxyalkylene compound (A) represented by the general formula (1) has one Q in a molecule. On the other hand, the defoaming agent contained in the electrodeposition coating composition of the present invention preferably contains the polyoxyalkylene compound having two or more of the Q's in a molecule. Namely, when the defoaming agent of the present invention contains the polyoxyalkylene compound represented by the general formula (1), the defoaming agent preferably contains the polyoxyalkylene compound represented by the general formula (2) or (3) simultaneously. In the present invention, the average number of the number of the Q per one molecule of the polyoxyalkylene compound contained in the defoaming agent is called as a “coupling number”. Further, the coupling number is preferably 1.5 to 5 and more preferably 2.0 to 4.0. When the coupling number is within the range, the defoaming property and the unevennes of drying preventing performance become further better.

When the L represents the reaction residual group of isocyanate, the L in the general formulae (1) to (3) represents a group represented by R¹—NH—CO— or a group represented by —CO—NH—R²—NH—CO— or the like.

R¹ can use alkyl, cycloalkyl, aryl and aralkyl (arylalkyl) and the like. Further, the portion of a hydrogen atom contained in these groups may be substituted with a halogen atom and/or alkoxy having a carbon number of 1 to 6, and the like. As alkyl, alkyl having a carbon number of 2 to 18 is used and includes ethyl, propyl, t-butyl, octyl, 2-ethylhexyl, octadecyl and the like. Additionally, chloroethyl, bromooctyl, dichloropropyl, ethoxyethyl, methoxyoctyl, butoxybutyl and the like can be also used. As cycloalkyl, cycloalkyl having a carbon number of 6 to 15 and the like are used and includes cyclohexyl, dicyclohexyl, methylcyclohexyl, trimethylcyclohexyl, nonylcyclohexyl and the like. Additionally, chlorocyclohexyl, methoxycyclohexyl, hexyloxycyclohexyl and the like can be also used. As aryl, aryl having a carbon number of 6 to 15 and the like are used and includes phenyl, tolyl, ethylphenyl, xylyl, nonylphenyl, naphthyl, biphenyl, anthryl, phenanthryl and the like. Additionally, bromophenyl, chloronaphthyl, chlorobiphenyl, methocyphenyl, butoxyphenyl and the like can be also used. As aralkyl, aralkyl having a carbon number of 7 to 18 and the like are used and includes a phenylmethyl group, tolylmethyl, ethylphenylmethyl, xylylmethyl, nonylphenylmethyl, naphthylmethyl, biphenylylmethyl, phenanthrylmethyl and the like. Additionally, bromophenylmethyl, chlorobiphenylmethyl, methoxyphenylmethyl and the like can be also used.

As R², alkylene, cycloalkylene, arylene and aralkylene(arylalkylene) and the like can be used. Further, the portion of a hydrogen atom contained in these groups may be substituted with a halogen atom and/or alkoxy having a carbon number of 1 to 6, and the like and the groups may be mutually bonded with an oxa group (—O—) or a sulfonyl group (—SO₂—). As alkylene, alkylene having a carbon number of 4 to 8 and the like are used and includes ethylene, propylene, butylene, 2-ethylhexylene and the like. Additionally, chloroethylene, bromooctylene, dichloropropylene, methoxyethylene, propoxyethylene, butoxypropylene and the like can be also used. As cycloalkylene, cycloalkylene having a carbon number of 6 to 15 and the like are used and includes cyclohexylene, dicyclohexylene, methylcyclohexylene, trimethylcyclohexylene, nonylcyclohexylene, a group represented by -(ch)-CH₂-(ch)-, a group represented by —CH₂-(ch)-(CH₂)—, a group represented by -(ch)-C(CH₃)₂-(ch)-, a group represented by -(ch)-CH₂CH₂-(ch)-, a group represented by -(tmch)-CH₂— and the like. Further, (ch) represents cyclohexylene and (tmch) represents trimethylcyclohexylene (hereinafter, the same). Additionally, a group represented by -(ch)-O-(ch)-, a group represented by -(ch)-SO₂-(ch)-, chlorocyclohexylene, methoxycyclohexylene and the like can be also used. As arylene, arylene having a carbon number of 6 to 15 and the like are used and includes phenylene, tolylene, methylphenylene, ethylphenylene, tetramethylphenylene, xylylene, nonylphenylene, naphthylene, biphenylene, diemthylbiphenylene, anthrylene, phenanthrylene, a group represented by -(ph)-CH₂-(ph)-, a group represented by -(ph)-C(CH₃)₂-(ph)-, a group represented by -(ph)-CH₂CH₂-(ph)-, a group represented by —CH₂-(ch)-CH₂—, and the like. Further, (ph) represents phenylene (hereinafter, the same) Additionally, a group represented by -(ph)-O-(ph)-, a group represented by -(ph)-SO₂-(ph)-, bromophenylene, chloronaphthylene, chlorobiphenylene, methocyphenylene and the like can be also used. As aralkylene, aralkylene having 7 to 18 a carbon number of and the like are used and includes a phenylethylene group, tolylbutylene, ethylphenylethylene, xylylhexylene, nonylphenylethylene, naphthylbutylene, biphenylylethylene, phenanthrylpropylene and the like. Additionally, bromophenylethylene, chlorophenylylethylene, a methoxyphenylethylene group, butoxynaphthylbutylene, diethoxybiphenylylethylene and the like can be also used. Among these, alkylene and cycloalkylene are preferable, a hexamethylene group and a trimethylcyclohexylmethylene group are further preferable and a hexamethylene group is preferable in particular.

When the L represents the reaction residual group of isocyanate, the polyoxyalkylene compound represented by the general formula (1) includes a compound indicated by the chemical formulae below and the like. Further, po represents an oxypropylene group, eo represents an oxyethylene group, Q¹ represents a sucrose residual group and Q² represents a raffinose residual group (hereinafter, the same).
H-{(po)₁ₐ}-Q¹-(po)-CONH—(CH₁)₃—CH₃ Chemical Formula (i)
H-{(po)₁ₐ-(eo)₂}₂-Q¹-(eo)-(po)-CONH—(CH₁)—CH Chemical Formula (ii)

When the L represents the reaction residual group of isocyanate, the polyoxyalkylene compound represented by the general formula (2) includes a compound indicated by the chemical formulae below and the like. Further, bo represents an oxybutylene group and tmch represents trimethylcyclohexylene (in particular, a residual group derived from isophorone diisocyanate (IPDI) is preferable) (hereinafter, the same).
H-{(po)}-Q¹-(po)-CONH—(CH₁)—CONH-(po)-Q¹-{(po)}-H Chemical Formula (iii)
H-{(bo)-(po)}-Q-(po)(bo)-CONH-((tmch)-CH) —CONH-(bo)₂-(po)-Q¹-{(po)-(bo)}-H Chemical Formula (iv)
H-{(bo)-(po)}-Q¹-(po)(bo)-CONH—(CH₁)—CONH-(bo)-(po)-Q¹-{(po)-(bo)}-H Chemical Formula (v)

When the L represents the reaction residual group of isocyanate, the polyoxyalkylene compound represented by the general formula (3) includes a compound indicated by the chemical formulae below and the like. Further, Q³ represents a melezitose residual group (hereinafter, the same).
H-{(po)-(eo)}-Q¹-CONH-((tmch)-CH) —CONH-Q¹{-(eo)-(po)}-H— Chemical Formula (vi)
H-{(po)-(eo)}-Q¹-CONH—(CH)—CONH-Q{-(eo)-(po)}-H Chemical Formula (vii)
H-{(po)-(eo-Q-CONH—(CH₁)—CONH-Q{-(eo)₄-(po)}-H Chemical Formula (viii)

Among these, the polyoxyalkylene compound represented by the general formula (2) or (3) is preferable, a compound represented by the chemical formula (iii), (iv), (vi) or (viii) is further preferable and a compound represented by the chemical formula (iii) or (vi) is preferable in particular.

When the L represents the reaction residual group of isocyanate, the polyoxyalkylene compound (A) represented by any one of the general formulae (1) to (3) includes a compound having a structure which can be produced by the chemical reaction of nonreducing disaccharide or trisaccharide (a1), alkylene oxide having a carbon number of 2 to 4 (a2) and isocyanate (a3-1). Further, the amount (parts by mol) of the alkylene oxide (a2) used is preferably 10 to 80 based on 1 part by mol of the nonreducing disaccharide or trisaccharide (a1), further preferably 12 to 75, particularly preferably 15 to 70 and most preferably 18 to 65. Namely, the amount (parts by mol) of the alkylene oxide (a2) used is preferably 10 or more based on 1 part by mol of nonreducing disaccharide or trisaccharide (a1), further preferably 12 or more, particularly preferably 15 or more and most preferably 18 or more. Further, it is preferably 80 or less, further preferably 75 or less, particularly preferably 70 or less and most preferably 65 or less. When the amount used is within the range, the defoaming property and the unevennes of drying preventing performance become further better. Further, the amount (parts by mol) of isocyanate (a3-1) used is preferably 0.1 to 0.8 based on 1 part by mol of nonreducing disaccharide or trisaccharide, further preferably 0.15 to 0.75, particularly preferably 0.2 to 0.7 and most preferably 0.25 to 0.65. Namely, the amount (parts by mol) of isocyanate (a3-1) used is preferably 0.1 or more based on 1 part by mol of nonreducing disaccharide or trisaccharide, further preferably 0.15 or more, particularly preferably 0.2 or more and most preferably 0.25 or more. Further, it is preferably 0.8 or less, further preferably 0.75 or less, particularly preferably 0.7 or less and most preferably 0.65 or less. When the amount used is within the range, the defoaming property and the unevennes of drying preventing performance become further better.

As the nonreducing disaccharide or trisaccharide (a1), those same as the disaccharide or trisaccharide which can form the reaction residual group (Q) in the general formulae (1) to (3) can be used and the preferable range is also same.

As the alkylene oxide (a2), alkylene oxide having a carbon number of 2 to 4 and the like can be used and includes ethylene oxide (EO), propylene oxide (PO), butylene oxide (BO) and the like. Among these, the PO and BO are preferable from the viewpoint of the defoaming property and the PO is further preferable. Further, a plural number of alkylene oxides may be used and in this case, there is no limit for the order of reaction (block shape, random shape and a combination thereof) and number. When the EO and PO and/or BO are contained therein, the PO and/or BO are preferably reacted after the EO. Further, a plural number of alkylene oxides are used, block shape is preferably contained. Further, when ethylene oxide is contained, the content is preferably 30% by weight or less based on the total weight of the alkylene oxide.

The isocyanate (a3-1) includes monoisocyanate, diisocyanate and the like. As the monoisocyanate, aliphatic monoisocyanate, aromatic monoisocyanate, alicyclic monoisocyanate and the like can be used. As the aliphatic monoisocyanate, alkyl isocyanate having a carbon number of 3 to 19 and the like are used and includes ethyl isocyanate, butyl isocyanate, hexyl isocyanate, 2-ethylhexyl isocyanate, nonyl isocyanate, isododecyl isocyanate, hexadecyl isocyanate, octadecyl isocyanate and the like. As the aromatic monoisocyanate, aryl isocyanate having a carbon number of 7 to 13 and the like are used and includes phenyl isocyanate, methylphenyl isocyanate, biphenyl isocyanate, naphthalene isocyanate and the like. As the alicyclic monoisocyanate, cycloalkyl isocyanate having a carbon number of 7 to 11 and the like are used and includes cyclohexyl isocyanate, dicyclohexyl isocyanate and the like.

As the diisocyanate, aliphatic diisocyanate, aromatic diisocyanate, alicyclic diisocyanate and the like can be used. As the aliphatic diisocyanate, alkylene diisocyanate having a carbon number of 6 to 8 and the like are used and includes 1,4-diisocyanatobutane, hexamethylene diisocyanate (HDI) and the like. As the aromatic diisocyanate, arylene diisocyanate having a carbon number of 8 to 15 and the like are used and includes p-phenylene diisocyanate, 2,4-tolylene diisocyanate (TDI), 4,4′-diphenylmethane diisocyanate (MDI), xylylene diisocyanate, 1,5-naphthalene diisocyanate and the like. As the alicyclic diisocyanate, cycloalkylene diisocyanate having a carbon number of 12 to 15 and the like are used and includes isophorone diisocyanate (IPDI), hydrogenated MDI, trnas-1,4-cyclohexane diisocyanate, hydrogenated TDI, hydrogenated 1,5-naphthalene diisocyanate and the like. Among these isocyanates, diisocyanate is preferable from the viewpoints of the defoaming property and the unevennes of drying preventing performance, 1,4-diisocyanatobutane, HDI, IPDI, MDI, 1,5-naphthalene diisocyanate and hydrogenated MDI are further preferable and HDI and IPDI are preferable in particular from the viewpoints of the coloring property of a product and the like. Polyisocyanate having 3 functions or more may be appropriately added to these monoisocyanate and diisocyanate to be used.

When the L represents the reaction residual group of isocyanate, the polyoxyalkylene compound (A) can be obtained by reacting the nonreducing disaccharide or trisaccharide (a1), the alkylene oxide (a2) and the isocyanate (a3-1). As the order of the reaction,

1. a method of reacting (a1) with (a2) and reacting (a3-1) with the reaction product (A12) (in general, the reaction product containing the polyoxyalkylene compound (A) represented by the general formula (1) or (2) is obtained) and

2. a method of reacting (a1) with (a3-1) and reacting (a2) with the reaction product (A13) (the reaction product containing the polyoxyalkylene compound (A) represented by the general formula (3) is obtained) are mentioned.

3. Additionally, (a2) can be also further reacted with the reaction product obtained by the method 1 (the reaction product containing the polyoxyalkylene compound (A) represented by the general formula (1) or (2) is obtained). Among these, the methods 2 and 3 are preferable and the method 2 is further preferable.

Reaction with alkylene oxide, namely, reaction of the nonreducing disaccharide or trisaccharide (a1) with the alkylene oxide (a2), the reaction of (a2) with the reaction product (a13) of (a1) with the isocyanate (a3-1), and the reaction of (a2) with the reaction product of (a1), (a2) and (a3-1) may be carried out by any form such as anionic polymerization, cationic polymerization or coordinated anionic polymerization. Further, these polymerization forms may be used alone or may be used in combination according to the degree of polymerization and the like.

A reaction catalyst can be used for reaction with the alkylene oxide (a2). As the reaction catalyst, a catalyst for the addition reaction of alkylene oxide generally used and the like can be used, and there can be used the hydroxide of an alkali metal or alkali earth metal (potassium hydroxide, rubidium hydroxide, cesium hydroxide and the like), the alcoholate of an alkali metal or alkali earth metal (potassium methylate, cesium ethylate and the like), the carbonate of an alkali metal or alkali earth metal (potassium carbonate, cesium carbonate and the like), tertiary amine having a carbon number of 3 to 24 (trimethylamine, trioctylamine, triethylenediamine, tetramethylethylenediamine and the like), Lewis acid (stannic chloride, boron trifluoride and the like). Among these, the hydroxide of an alkali metal and tertiary amine are preferable and potassium hydroxide, cesium hydroxide and trimethyl amine are more preferable.

When the reaction catalyst is used, its use amount (% by weight) is preferably 0.05 to 2 based on the weight of a reaction product at completion of the reaction, further preferably 0.1 to 1 and particularly preferably 0.2 to 0.6. Namely, in this case, the amount (% by weight) of the reaction catalyst used is preferably 0.05 or more based on the weight of a reaction product at completion of the reaction, further preferably 0.1 or more and particularly preferably 0.2 or more, and preferably 2 or less, further preferably 1 or less and particularly preferably 0.6 or less. Further, when amide illustrated below is used as a reaction solvent, the reaction catalyst is not required to be used. Further, the reaction catalyst is preferably removed from the reaction product. Its method includes a method of using an alkali absorbent (for example, trade name: KYOWARD 700 manufactured by Kyowa Chemical Industry Co., Ltd.) such as synthetic aluminosilicate (Japanese Patent Kokai Publication No. 123499/1978 and the like), a method of dissolving it in a solvent such as xylene or toluene to be rinsed (Japanese Patent Kokoku Publication No. 14359/1974), a method of using an ion exchange resin (Japanese Patent Kokai Publication No. 23211/1975 and the like), a method of neutralizing an alkaline catalyst with carbon dioxide gas and filtrating carbonate salt generated (Japanese Patent Kokoku Publication No. 33000/1977), and the like. As the end point of removing the reaction catalyst, the value of CPR (Controlled Polymerization Rate) described in JIS K1577-1970 is preferably 20 or less, more preferably 10 or less, particularly preferably 5 or less and most preferably 1 or less.

For the reaction with the alkylene oxide (a2), a pressure proof reactor capable of heating, cooling and stirring is preferably used. Reaction atmosphere is preferably vacuum before introducing the alkylene oxide (a2) into a reaction system or the atmosphere of inert gas (argon, nitrogen, carbon dioxide and the like). Further, the reaction temperature (0° C.) is preferably 80 to 150° C. and more preferably 90 to 130° C. The reaction pressure (gauge pressure: MPa) is preferably 0.8 or less and more preferably. 0.5 or less. The confirmation of the reaction end point can be carried out by the following method and the like. Namely, when the reaction temperature is kept at constant for 15 minutes, the time when the lowering of the reaction pressure (gauge pressure) is 0.001 MPa or less is considered as the end point of the reaction. The required reaction time is usually 4 to 12 hours.

Reaction with isocyanate, namely, the reaction of the isocyanate (a3-1) with the reaction product (a12) of the nonreducing disaccharide or trisaccharide (a1) with the alkylene oxide (a2) or the reaction of (a1) with the isocyanate (a3-1) is an addition reaction and in case of reaction with isocyanate having a low reaction speed (aliphatic or alicyclic mono- or di-isocyanate and the like), a reaction catalyst can be used for aiming the shortening of reaction time, for example, in case of HDI and IPDI. As the reaction catalyst, dibutyltin dilaurate, stannous octoate, triethylenediamine and the like are general. Further, when amide illustrated below is used as a reaction solvent, the reaction catalyst is unnecessary.

For the reaction with the isocyanate (a3-1), a closed reactor capable of heating, cooling and stirring can be used. The reaction temperature (0° C.) is preferably 70 to 150° C. and more preferably 90 to 130° C. Reaction atmosphere is preferably under the atmosphere of dried inert gas. The confirmation of the reaction end point can be carried out by the following method and the like. Namely, the time when the content of an isocyanate group is 0.01% by weight or less in the measurement-method of the content of an isocyanate group using the dioxane solution of di-n-butylamine is considered as the end point of the reaction.

A reaction solvent can be used for the reaction with the alkylene oxide (a2) and the reaction with the isocyanate (a3-1). Among these reactions, the reaction solvent is preferably used for the reaction step of the nonreducing disaccharide or trisaccharide (a1) with the alkylene oxide (a2) and/or the reaction step of (a1) with the isocyanate (a3-1). As the reaction solvent, any solvent can be used so far as it has not active hydrogen and dissolves the nonreducing disaccharide or trisaccharide (a1), the alkylene oxide (a2), the reaction product (a12) of (a1) with (a2) and the isocyanate (a3-1), the reaction product (a13) of (a1) with (a3-1), or the reaction product of (a1), (a2) and (a3-1).

As the reaction solvent, alkylamide having a carbon number of 3 to 8 and heterocyclic amide having a carbon number of 5 to 7 can be used. The alkylamide includes N,N-dimethylformamide (DMF), N,N-dimethylacetoamide, N,N-diethylacetoamide, N-methyl-N-propylacetoamide, 2-dimethylacetoaminoaldehyde dimethylacetal and the like. The heterocyclic amide includes N-methylpyrrolidone, N-methyl-ε-caprolactam, N,N-dimethylpyrrolecarboxylic acid amide and the like.

Among these, alkylamide and N-methylpyrrolidone are preferable, DMF, N,N-dimethylacetoamide and N-methylpyrrolidone are more preferable, DMF and N-methylpyrrolidone are preferable in particular and DMF is most preferable. When the reaction solvent is used, its use amount (% by weight) is preferably 20 to 200 based on the weight of the reaction product, further preferably 40 to 180 and particularly preferably 60 to 150. Namely, in this case, the amount (% by weight) of the reaction solvent used is preferably 20 or more based on the weight of the reaction product, further preferably 40 or more and particularly preferably 60 or more, and preferably 200 or less, further preferably 180 or less and particularly preferably 150 or less.

When the reaction solvent is used, the reaction solvent is preferably removed by distillation under reduced pressure and by adsorption removal if necessary. Further, the residual amount (% by weight) of the reaction solvent is preferably 0.1 or less based on the weight of the polyoxyalkylene compound (A), further preferably 0.05 or less and particularly preferably 0.01 or less. Further, the residual amount of the reaction solvent can be determined by gas chromatography using an internal standard substance. In case of distillation under reduced pressure, a distillation method at 100 to 150° C. under reduced pressure of 200 to 5 mmHg and the like can be applied. Further, in case of adsorption removal, a treatment method of using an alkali absorbent (for example, trade name; KYOWARD 700 manufactured by Kyowa Chemical Industry Co., Ltd.) such as synthetic aluminosilicate, and the like can be applied. For example, when KYOWARD 700 is used, the addition amount (% by weight) of the alkali absorbent is about 0.1 to 10 based on the weight of the polyoxyalkylene compound (A), the treatment temperature is about 60 to 120° C. and the treatment time is about 0.5 to 5 hours. The residual amount of the reaction solvent can be further reduced by successively filtrating it using a filter paper or the like, and removing the alkali absorbent.

When the L represents the reaction residual group of dihalogenated alkyl, the L in the general formulae (1) to (3) represents hydrocarbon having a carbon number of 1 to 4. The example of the hydrocarbon having a carbon number of 1 to 4 includes an alkylene group having a carbon number of 1 to 4, an alkynylene group having a carbon number of 1 to 4 and the like. The alkylene group includes a methylene group, an ethylene group, a propylene group, an isopropylene group, a butylene group and the like. The alkynylene group includes an ethynylene group, a propenylene group, a butenylene group, a butadienylene group and the like. Among these, an alkylene group is preferable, an alkylene group having a carbon number of 1 to 3, namely, a methylene group, an ethylene group:, a propylene group or an isopropylene group is more preferable and a methylene group or an ethylene group is most preferable.

When the L represents the reaction residual group of dihalogenated alkyl, the polyoxyalkylene compound (A) represented by the general formula (2) is preferable. The preferable polyoxyalkylene compound (A) includes compounds indicated by the chemical formulae below and the like. Further, the symbols in the chemical formulae have similar meaning to the above.
[{C₂H₅-(po)₁₄-(eo)-}₂Q¹-(eo)-Po)₁₄-C₂H₄-(po)₁₄-(eo)]₂-Q¹-(eo)-(po)₁₄-C₂H₅ Chemical Formula (ix)
{CH₃-(po)}₂-Q¹-(po)-CH₃)₂ Chemical Formula (x)
[{CH₃-(po)₇-}₂Q¹-(po)₇-CH₂-(po)₇-]₂-Q¹-(po)₇-CH Chemical Formula (xi) 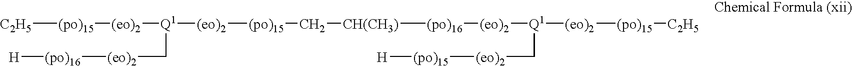 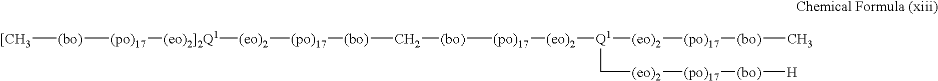
H-(po)-(eo)₂-Q²-(eo)₂-(po)₂₈-CH₂—CH₂-(po)₂₆-(eo)Q²-(eo)₂ -(po)₂₆-H Chemical Formula (xiv)

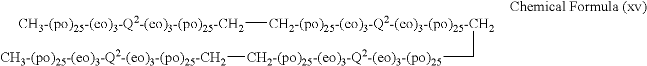

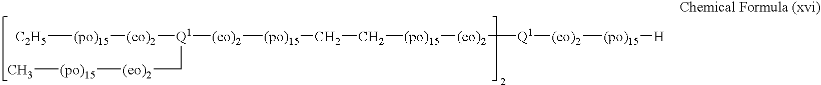

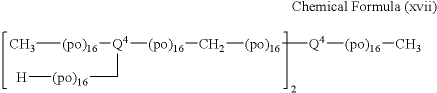

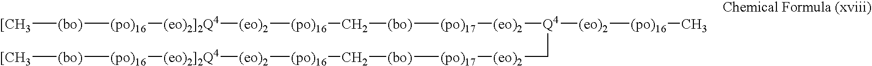

Among these, the polyoxyalkylene compounds represented by the chemical formula (ix), (xii), (xiii), (xvi) or (xviii) are preferable and the polyoxyalkylene compounds represented by the chemical formula (ix) or (xvi) are further preferable.

When the L represents the reaction residual group of dihalogenated alkyl, a polyoxyalkylene compound and the like having a structure which can be produced by the chemical reaction of the nonreducing disaccharide or trisaccharide (a1), the alkylene oxide (a2) having a carbon number of 2 to 4, the dihalogenated hydrocarbon having a carbon number of 1 to 4 (a3-21) and a monohalogenated hydrocarbon having a carbon number of 1 to 3 (a3-22) if necessary are included as the polyoxyalkylene compound (A) represented by any one of the general formulae (1) to (3). Namely, the polyoxyalkylene compound having a structure which can be produced by these chemical reactions generates occasionally distribution in the number of an oxyalkylene group and the t, and in such a case, it is a mixture of plural kinds of polyoxyalkylene compounds is obtained; therefore the polyoxyalkylene compound represented by any one of the general formulae (1) to (3) is contained in the mixture. Further, even in such case, the production process is not limited.

Further, the amount (part by mol) of the alkylene oxide (a2) used is preferably 10 to 80 based on 1 part by mol of the nonreducing disaccharide or trisaccharide (a1), further preferably 13 to 77, particularly preferably 16 to 73 and most preferably 20 to 70. Namely, the lower limit of the amount (part by mol) of the alkylene oxide (a2) used is preferably 10 based on 1 part by mol of the (a1), further preferably 13, particularly preferably 16 and most preferably 20. Further, similarly, the upper limit is preferably 80, further preferably 77, particularly preferably 73 and most preferably 70. When it is within the range, the defoaming property and the unevennes of drying become further better.

The amount (part by mol) of the dihalogenated hydrocarbon having a carbon number of 1 to 4 (a3-21) used is preferably 0.2 to 0.9 based on 1 part by mol of the nonreducing disaccharide or trisaccharide (a1), further preferably 0.25 to 0.85, particularly preferably 0.3 to 0.8 and most preferably 0.35 to 0.75. When it is within the range, the defoaming property and the unevennes of drying become further better.

Further, when the monohalogenated hydrocarbon having a carbon number of 1 to 3 (a3-22) is not used in combination, the amount (part by mol) of the dihalogenated hydrocarbon having a carbon number of 1 to 4 (a3-21) used is preferably 0.3 to 0.9 based on 1 part by mol of the nonreducing disaccharide or trisaccharide (a1), further preferably 0.35 to 0.85, particularly preferably 0.4 to 0.8 and most preferably 0.45 to 0.75. Namely, the lower limit of the amount (part by mol) of the (a3-21) used is preferably 0.3 based on 1 part by mol of the (a1), further preferably 0.35, particularly preferably 0.4 and most preferably 0.45. Further, similarly, the upper limit is preferably 0.9, further preferably 0.85, particularly preferably 0.8 and most preferably 0.75. When it is within the range, the defoaming property and the unevennes of drying become further better.

Further, when the monohalogenated hydrocarbon having a carbon number of 1 to 3 (a3-22) is used in combination, the amount (part by mol) of the dihalogenated hydrocarbon having a carbon number of 1 to 4 (a3-21) used is preferably 0.2 to 0.7 based on 1 part by mol of the nonreducing disaccharide or trisaccharide (a1), further preferably 0.25 to 0.65, particularly preferably 0.3 to 0.6 and most preferably 0.35 to 0.55. Namely, the lower limit of the amount (part by mol) of the (a3-21) used is preferably 0.2 based on I1 part by mol of the (a1), further preferably 0.25, particularly preferably 0.3 and most preferably 0.35. Further, similarly, the upper limit is preferably 0.7, further preferably 0.65, particularly preferably 0.6 and most preferably 0.55. When it is within the range, the defoaming property and the unevennes of drying become further better.

When the monohalogenated hydrocarbon having a carbon number of 1 to 3 (a3-22) is used, the use amount (part by mol) is preferably 0.1 to 3 based on 1 part by mol of the nonreducing disaccharide or trisaccharide (a1), further preferably 0.5 to 2.8, particularly preferably 0.8 to 2.7 and most preferably 1 to 2.5. Namely, when the (a3-21) is used, the lower limit of the use amount (part by mol) is preferably 0.1 based on 1 part by mol of the (a1), further preferably 0.5, particularly preferably 0.8 and most preferably 1. Further, similarly, the upper limit is preferably 3, further preferably 2.8, particularly preferably 2.7 and most preferably 2.5. When it is within the range, the defoaming property and the unevennes of drying become further better.

As the nonreducing disaccharide or trisaccharide (a1), those same as the disaccharide or trisaccharide capable of composing the reaction residual group (Q) in the general formulae (1) to (3) can be used and the preferable rage is also same.

As the alkylene oxide (a2), alkylene oxide having a carbon number of 2 to 4 and the like can be used and includes ethylene oxide (EO), propylene oxide (PO), butylene oxide (BO), a mixture thereof and the like. Among these, a mixture containing PO and BO, and PO are preferable from the viewpoints of water resistance and the like.

Further, when plural kinds of alkylene oxides are used, the order of reaction (block shape, random shape or a combination thereof) and proportion used are not limited, but a block shape or the combination of the block shape and random shape is preferably contained. Further, it is preferable to contain the PO in this case. When the BO is used, the proportion used (% by mol) is preferably 2 to 20 based on the total moles of alkylene oxide, further preferably 3 to 18, particularly preferably 4 to 17 and most preferably 5 to 15. Namely, in this case, the lower limit of the proportion of the BO used (% by mol) is preferably 2 based on the total weight of alkylene oxide, further preferably 3, particularly preferably 4 and most preferably 5. Further, similarly, the upper limit is preferably 20, further preferably 18, particularly preferably 17 and most preferably 15. Further, the EO and PO or/and BO are contained, it is preferable that the PO and/or BO are reacted after the reaction of EO to (a1).

As the dihalogenated hydrocarbon (a3-21), a dihalogenated aliphatic hydrocarbon and the like can be used and dihalogenated alkane having a carbon number of 1 to 4, dihalogenated alkylene having a carbon number of 2 to 4 and the like are used. The dihalogenated alkane includes dichloromethane, dibromomethane, 1,2-dichloroethane, 1,2-dibromoethane, 1,1-dichloroethane, 1,1-dibromoethane, 1,3-dichloropropane, 1,2-dichloropropane, 1,3-dibromopropane, 1,2-dibromopropane, 1-bromo-3-chloropropane, 1-methyl-1,2-dichloroethane, 1-methyl-1,2-dibromoethane, 1,4-dichlorobutane, 1,4-dibromobutane, 2,3-dichlorobutane and the like.

The, dihalogenated alkylene includes 1,2-dichloroethylene, 1,2-dibromoethylene, 1,3-dichloropropene, 2,3-dichloro-1-propene, 1,3-dibromopropene, 2.3-dibromo-1-propene, 1,2-dichloro-3-butene, 1,4-dichloro-2-butene and the like.

Among these, dihalogenated alkane is preferable from the viewpoints of the defoaming property and the unevennes of drying, dichloromethane, dichloroethane, 1,3-dichloropropane and 1-methyl-1,2-dichloroethane are further preferable and dichloromethane and dichloroethane are preferable in particular from the viewpoints of low viscosity and the like. These may be used alone or in a mixture.

As the monohalogenated hydrocarbon (a3-22), monohalogenated alkane having a carbon number of 1 to 3 and monohalogenated alkylene having a carbon number of 3 and the like can be used. The monohalogenated alkane includes monochloromethane, monobromomethane, monochloroethane, monobromoethane, 2-bromopropane, 1-chloropropane, 2-chloropropane and the like. Monohalogenated alkylene includes 1-chloropropene, 1-bronfopropene, 2-bromopropene, 2-chloropropene and the like. Among these, monochloromethane, monobromomethane, monochloroethane, monobromoethane, 2-bromopropane, 2-chloropropane, 1-chloropropene and 1-bromopropene are preferable, monochloromethane, monobromomethane, monochloroethane, monobromoethane, 1-chloropropene and 1-bromopropene are further preferable and monochloromethane, monobromomethane, monochloroethane and monobromoethane are preferable in particular. These may be used alone or in mixture.

The polyoxyalkylene compound (A) can be obtained by reacting the nonreducing disaccharide or trisaccharide (a1), the alkylene oxide (a2), the dihalogenated hydrocarbon (a3-21) and the monohalogenated hydrocarbon (a3-22) if necessary, but its general production process is as follow.

1. Firstly, the (a1) and (a2) are reacted to obtain the reaction product (a12). Then, the (a12) and (a3-21) are reacted to obtain a reaction product and this is further reacted with (a3-22) if necessary, to obtain the polyoxyalkylene compound (A).

2. Firstly, the (a1) and (a2) are reacted to obtain the reaction product (a12). Then, the (a12) and (a3-22) are reacted if necessary, to obtain a reaction product and this is further reacted with (a3-21) to obtain the polyoxyalkylene compound (A).

3. Firstly, the (a1) and (a2) are reacted to obtain the reaction product (a12). Then, a mixture of the (a12), (a3-21) and (a3-22) if necessary is reacted to obtain the polyoxyalkylene compound (A).

Any of these methods may be used, but the method 3 is preferable.

The addition reaction of the nonreducing disaccharide or trisaccharide (a1) with the alkylene oxide (a2) may be carried out by any form such as anionic polymerization, cationic polymerization or coordinated anionic polymerization. Further, these polymerization forms may be used alone or may be also used in combination according to the degree of polymerization and the like. The addition reaction of the alkylene oxide (a2) can be carried out in the same manner as the above.

In the addition reaction step of the alkylene oxide (a2), a reaction solvent is preferably used. As the reaction solvent, a solvent having no active hydrogen is preferable, and those which dissolve the nonreducing disaccharide or trisaccharide (a1), the alkylene oxide (a2) and the reaction product (a12) prepared by reaction with the (a2) are further preferable. As the reaction solvent, the above-mentioned alkylamide having a carbon number of 3 to 8, heterocyclic amide having a carbon number of 5 to 7 and the like can be used.

When the reaction solvent is used, its use amount (% by weight) is preferably 20 to 200 based on the weight of the product (a12) which is produced by the reaction of (a1) with (a2), further preferably 40 to 180 and particularly preferably 60 to 150. Namely, in this case, the lower limit of the amount (% by weight) of the reaction solvent used is preferably 20, further preferably 40 and particularly preferably 60 based on the weight of the product (a12) which is produced by the reaction of (a1) with (a2). Further, similarly, the upper limit is preferably 200, further preferably 180 and particularly preferably 150. When the reaction solvent is used, it is preferable to remove the reaction solvent after reaction in the same manner as the above.

The reaction of the reaction product (a12) with the dihalogenated hydrocarbon (a3-21) and the monohalogenated hydrocarbon (a3-22) in necessary (hereinafter, occasionally abbreviated as the halogenated hydrocarbon) is dehydrogenation reaction by a basic substance (Williamson synthesis reaction: reaction is promoted by neutralizing hydrogen halide successively produced in the reaction, with a basic substance). The example of the basic substance which can be used for the reaction includes the hydroxides of alkali metal or alkali earth metal (lithium hydroxide, sodium hydroxide, potassium hydroxide, rubidium hydroxide, cesium hydroxide, magnesium hydroxide, calcium hydroxide, barium hydroxide and the like), the alcoholates of alkali metal (a carbon number of 1 to 2: sodium methylate, potassium methylate and the like), the carbonate of alkali metal or alkali earth metal (sodium carbonate, potassium carbonate, barium carbonate and the like). Among these, the hydroxide of alkali metal is preferable, sodium hydroxide and potassium hydroxide are further preferable and sodium hydroxide is preferable in particular.

In this case, the amount of the basic substance used is preferably an amount of 100 to 150 based on the equivalent (eq.) of halogen of the halogenated hydrocarbon as the base equivalent (eq.) of the basic substance, further preferably an amount of 105 to 140 and particularly preferably an amount of 110 to 130. Namely, in this case, the lower limit of the amount of the basic substance used is preferably an amount of 100 based on the equivalent of halogen of the halogenated hydrocarbon as the base equivalent of the basic substance, further preferably 105 and particularly preferably an amount of 110. Further, similarly, the upper limit is preferably an amount of 150, further preferably an amount of 140 and particularly preferably an amount of 130.

It is preferable to remove a neutral salt produced and the residual basic substance after completion of the reaction, and its method includes (1) a method of firstly removing the neutral salt produced and the like by filtration and then removing the residual basic substance and the like using an absorbent and the like, (2) an extraction method by an organic solvent and (3) a salting-out method by sodium chloride, etc.

The method of (1) can remove them in the same manner as the removal of a reaction catalyst used for the addition reaction of the alkylene oxide (a2).

The extraction method of (2) is a method by which water and an organic solvent (solvents such as hexane, toluene and xylene whose solubility in water is extremely low) are added to the reaction product, extracting the reaction product in the organic solvent layer by shaking and separating the basic substance in a water layer. Further, the organic solvent layer is further rinsed with deionized water and the like. The volume ratio of the reaction product : water : the organic solvent is suitable nearly 1:1:1.

The salting-out method of (3) is a method by which the reaction product is precipitated from a water layer by adding and shaking the nearly equal volume of water and an appropriate amount of sodium chloride t (3 to 10% by weight for water) and the like to the reaction product and thereby the basic substance is separated from the water layer.

In case of (2) or (3), it is preferable to completely remove the basic substance finally using an alkali absorbent (for example, KYOWARD 700) such as synthetic aluminosilicate.

As the end point of the removal of the basic substance, CPR (Controlled Polymerization Rate) value described in JIS K1557-1970 is preferably 20 or less, further preferably 10 or less, particularly preferably 5 or less and most preferably 2 or less.

Further, it is preferable that moisture is removed. In this case, dehydration is carried out at 100 to 130° C. for 1 to 2 hours under reduced pressure (100 to 1 mmHg). Moisture in a product is preferably 0.5% by weight or less and further preferably 0.05% by weight or less. Further, the moisture can be measured by known methods and for example, can be measured by Karl Fischer method (JIS K0113-1997, coulometric titration method) and weight decrease by thermal drying (for example, 0.5 g of a sample is dried at 130° C. for one hour and weight change before and after drying is measured).

As the reactor, a pressure proof reactor capable of heating, cooling and stirring is preferably used. Reaction atmosphere is preferably vacuum or the atmosphere of dried inert gas (argon, nitrogen, carbon dioxide and the like) before introducing the (a3-21), and (a3-22) according to requirement into a reaction system. Further, the reaction temperature (° C.) is preferably 60 to 160 and more preferably 80 to 130. The reaction pressure (gauge pressure: MPa) is preferably 0.8 or less and more preferably 0.5 or less.

The confirmation of the reaction end point can be carried out by the following method and the like. Namely, when the reaction temperature is kept at constant for 15 minutes, the time when the lowering of the reaction pressure (gauge pressure) is 0.001 MPa or less is considered as the end point of the reaction. The requisite reaction time is usually 1 to 6 hours.

Further, Williamson synthesis reaction is also described in Japanese Patent Publication No. 339364/2004. However, in Japanese Patent Publication No.339364/2004, it is used for further bonding a polyoxyalkylene group with only the partial hydroxyl group (including the terminal hydroxyl group of the polyoxyalkylene group) of a polyoxyalkylene compound. On the other hand, in the present invention, it is used for preparing the polyoxyalkylene compound (A) having a coupling structure by reacting the above-mentioned reaction product (a12) with the dihalogenated hydrocarbon (a3-21) and the monohalogenated hydrocarbon (a3-22) if necessary; therefore the present invention differs in that point. In the present invention, the polyoxyalkylene compound (A) having a coupling structure can be prepared by selecting the amount of the reaction substance and the basic substance used and suitably controlling reaction condition and the like.

Cationic Resin

A cationic resin is a resin having a functional group, and a component which is cured by a block isocyanate curing agent to be functionalized as the binder resin of cationic electrodeposition coating. In the cationic electrodeposition coating composition containing the defoaming agent of the present invention, a cationic epoxy resin (i) in which an active hydrogen compound such as amine is reacted with the epoxy ring of an epoxy resin as a cationic resin and a cationic group is introduced by opening the ring of the epoxy group is used.

Further, a polyamide resin (ii) having a basic amino group may be used in combination as the cationic resin. The reason is that the crosslinking density of cured coating is lowered thereby to improve impact resistance and superior effect in flexibility and adherence property is obtained.

The cationic epoxy resin used in the present invention includes an epoxy resin modified with amine. The cationic epoxy resin is typically produced by opening all of the epoxy ring of a bisphenol type epoxy resin with an active hydrogen compound which can introduce a cationic group, or by opening the portion of an epoxy ring with other active hydrogen compound and opening the residual epoxy ring with an active hydrogen compound which can introduce a cationic group.

The typical example of the bisphenol type epoxy resin is a bisphenol A type epoxy resin or a bisphenol F type epoxy resin. The commercially available product of the former includes Epikote 828 (manufactured by Yuka-Shell Epoxy Co., Ltd., epoxy equivalent: 180 to 190), Epikote 1001 (the same, epoxy equivalent: 450 to 500), Epikote 1010 (same, epoxy equivalent: 3000 to 4000) and the like and the commercially available product of the latter includes Epikote 807 (same, epoxy equivalent: 170) and the like.

An epoxy resin containing an oxazolidone ring which is indicated by the formula below which is described in JP-A No. 5-306327: 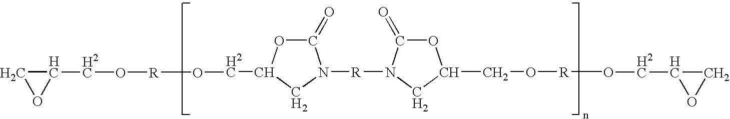
Wherein R means a residual group formed by removing the glycidyloxy group of a diglycidylepoxy compound, R′ means a residual group formed by removing the isocyanate group of a diisocyanate compound and n means a positive integer, may be used as the cationic epoxy resin. This is because coating superior in heat resistance and corrosion resistance is obtained.

As the method of introducing the oxazolidone ring into the epoxy resin, for example, a blocked polyisocyanate which is blocked with lower alcohol such as methanol and polyepoxide are heated in the presence of a basic catalyst to keep its temperature and it is obtained by distilling lower alcohol by-produced, from the system.

The preferable epoxy resin in particular is an epoxy resin containing an oxazolidone ring. This is because coating superior in heat resistance and corrosion resistance and further also superior in impact resistance is obtained.

It is well known that the epoxy resin containing an oxazolidone ring is obtained by reacting a bifunctional epoxy resin with a diisocyanate (namely, bisurethane) which is blocked with monoalcohol. The specific example and production process of the epoxy resin containing an oxazolidone ring are described in, for example, the paragraphs 0012 to 0047 of Japanese Patent Publication No. 128959/2000 and well known.

These epoxy resins may be modified with appropriate resins such as polyester polyol, polyether polyol and monofunctional alkylphenol. Further, the epoxy resin can extend its chain utilizing the reaction of an epoxy group with diol or dicarboxylic acid.

It is desirable that the ring of these epoxy resins is opened by an active hydrogen compound so that an amine equivalent is 0.3 to 4.0 meq/g after ring opening and the primary amino group occupies more preferably 5 to 50% therein.

The active hydrogen compound capable of introducing the cationic group includes the acid salts of the primary amine, secondary amine and tertiary amine, sulfide and an acid mixture. The acid salts of primary amine, secondary amine and tertiary amine are used as the active hydrogen compound capable of introducing the cationic group in order to prepare an epoxy resin containing primary amino, secondary amino and tertiary amino groups.

The specific examples include butyl amine, octylamine, diethylamine, dibutylamine, methylbutylamine, monoethanolamine, diethanolamine, N-methylethanolamine, triethylamine hydrochloride, N,N-dimethylethanolamine acetate, a mixture of diethylsulfide and acetic acid, additionally, the secondary amine blocking the primary amine such as the ketimine of aminoethylethanolamine and the diketimine of diethylenetriamine. A plural number of amines may be used.

The polyamide resin (ii) having a basic amino group which may be used in combination with the amine modified epoxy resin (i) as the cationic resin includes condensation polymers of dicarboxylic acids such as phthalic acid, adipic acid, sebacic acid and dimer fatty acid with polyamines such as ethyl enediamine, hexamethylenediamine, diethylenetriamine, triethylenetetramine, propylenediamine and butylenediamine; polyamides obtained by further condensing oligomers which are obtained by carrying out the ring opening polymerization of lactam such as c-caprolactam, with polyamine; polyester polyamides obtained by using alkanolamines such as ethanolamine and propanolamine in place of polyamine, etc. These resins have an amino group and an amide group in the molecule and can be reacted with an isocyanate group. Further, the polyester polyamides have also a hydroxyl group in the molecule and can be reacted with an isocyanate group.

The cationic epoxy resin (i) and the polyamide resin (ii) may be reacted by merely mixing. When the cationic epoxy resin (i) is reacted with the polyamide resin (ii), the compatibility of both is enhanced. In this case, the amount of the epoxy group to be remained is desirably a level at which a reaction product is gelled and not too highly viscous, namely, one or less per one molecule of the epoxy resin. The reaction is carried out at 50 to 200° C. and preferably 80 to 150° C. As the reaction solvent, a compound such as methyl isobutyl ketone, cellosolve acetate or ventoxon which is not reacted with an isocyanate group may be used. The mixing ratio or reaction ratio of (i) and (ii) is 90 to 10% by weight of the latter based on 10 to 90% by weight of the former and preferably 70 to 30% by weight of the latter based on 30 to 70% by weight of the former.

The mixture or reaction product of the cationic epoxy resin (i) with the polyamide resin (ii) may be further reacted with a blocked isocyanate curing agent. At that time, the block of isocyanate is required to be partial. Further, gelation is prevented by reacting so that the blocked isocyanate group is not dissociated. The reaction temperature is 60 to 120° C. and preferably 80 to 100° C.

(i) and/or (ii) may preliminarily be reacted with ketones such as acetone, methyl ethyl ketone and methyl isobutyl ketone to convert the primary amine to ketimine for protection so that the primary amino group contained in (i) and/or (ii) are protected and an amino group enough for solubilizing with acid remains or gelation is prevented. The production reaction of ketimine proceeds easily by heating to 100° C. or more and distilling off water prepared. Further, solvents inactive for an isocyanate group such as, for example, butyl acetate, cellosolve acetate, diethyleneglycol dimethyl ether, methyl isobutyl ketone and ventoxon may be used for lowering the viscosity of a product and preventing gelation in the reaction.

The reaction ratio of a mixture or a reaction product of the cationic epoxy resin (i) and the polyamide resin (ii) to the blocked isocyanate curing agent is 50 to 10% by weight of the latter based on 50 to 90% by weight of the former and preferably 40 to 15% by weight of the latter based on 60 to 85% by weight of the former. When it is within the range, the erosion resistance and hardness of coating is improved and simultaneously, it is also superior in the smoothness and impact strength.

Further, the amine value of the reaction product obtained is 25 to 400 and preferably 50 to 200. When the amine value is within the range, it is superior in dispersibility in water, the erosion resistance of coating obtained is improved and it is also superior in electrodeposition efficiency.

Blocked isocyanate Curing Agent

The blocked isocyanate curing agent is a component which cures the cationic resin and functions as the binder resin of the cationic electrodeposition coating. As the blocked isocyanate curing agent, a blocked polyisocyanate in which the isocyanate group of a polyisocyanate is blocked is preferably used. The polyisocyanate means a compound having 2 or more of isocyanate groups in a molecule. As the polyisocyanate, for example, any one of an aliphatic type, an alicyclic type, an aromatic type and an aromatic-aliphatic type may be used.

The specific example of the polyisocyanate includes tolylene diisocyanate (TDI), aromatic diisocyanates such as diphenylmethane diisocyanate (MDI), p-phenylene diisocyanate and naphthalene diisocyanate; aliphatic diisocyanates having a carbon number of 3 to 12 such as hexamethylene diisocyanate (HDI), 2,2,4-trimethylhexane. diisocyanate and lysine diisocyanate; alicyclic diisocyanates having a carbon number of 5 to 18 such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate and 1,3-diisocyanatomethylcyclohexane (hydrogenated XDI), hydrogenated TDI and 2,5- or 2,6-bis(isocyanatomethyl)-bicyclo[2,2,1]heptane (also called as norbornene diisocyanate); aliphatic diisocyanates having an aromatic ring such as xylylene diisocyanate (XDI) and tetramethylxylylene diisocyanate (TMXDI); the modified product of these diisocyanates (urethanated product, carbodiimides, urethodione, urethoimine, biuret and/or isocyanurate modified product), etc. These can be used alone or 2 or more thereof can be used in combination.

An adduct or a prepolymer which is obtained by reacting polyisocyanate with polyvalent alcohols such as ethylene glycol, propylene glycol, trimethylolpropane and hexanetriol at an NCO/OH ratio of 2 or more may be also used for the blocked isocyanate curing agent.

The blocking agent is added to a polyisocyanate group, stable at normal temperature, but can regenerate a free isocyanate group when it is heated to dissociation temperature or more.

Pigment

An electrodeposition coating composition contains generally pigments as colorants. The cationic electrodeposition coating composition containing the defoaming agent of the present invention contains also pigments usually used if necessary. The example of the pigments includes coloring pigments such as titanium white, carbon black and colcothar; body pigments such as kaoline, talc, aluminum silicate, calcium carbonate, mica, clay and silica; anticorrosive pigments such as zinc phosphate, iron phosphate, aluminum phosphate, calcium phosphate, zinc phosphite, zinc cyanide, zinc oxide, aluminum tripolyphosphate, zinc molybdate, aluminum molybdate, calcium molybdate, aluminum phosphomolybdate and aluminum zinc phosphomolybdate.

Pigment Dispersion Paste

When a pigment is used as the component of electrodeposition coating, the pigment is generally preliminarily dispersed in aqueous medium at high concentration to be paste shape. Since the pigment is powder, it is difficult to disperse it by one step to a uniform low concentration state which is used for the electrodeposition coating composition. In general, the paste is called as pigment dispersion paste.

The pigment dispersion paste is prepared by dispersing pigments in aqueous medium together with a pigment dispersion resin. As the pigment dispersion resin, there are generally used a cationic or nonionic low molecular weight surfactant and cationic polymers such as a modified epoxy resin having a quaternary ammonium group and/or tertiary sulfonium group. As the aqueous medium, ion exchanged water, water containing a small amount of alcohols and the like are used. Generally, the pigment dispersion resin is used at a solid content ratio of 5 to 40 parts by weight and pigments are used at a solid content ratio of 20 to 50 parts by weight.

Cationic Electrodeposition Coating Composition

The cationic electrodeposition coating composition of the present invention is prepared by dispersing at least the above-mentioned cationic resin, the binder resin containing the blocked isocyanate curing agent and the defoaming agent in aqueous medium. Further, the composition contains preferably the above-mentioned metal catalyst, the pigment dispersion paste and the like.

As the aqueous medium, ion exchanged water and the like are generally used. Further, neutralizing acid is usually contained in the aqueous medium for neutralizing the cationic epoxy resin and improving the dispersibility of the binder resin emulsion. The neutralizing acid is inorganic acids or organic acids such as hydrochloric acid, nitric acid, phosphoric acid, formic acid, acetic acid and lactic acid.

The amount of the blocked isocyanate curing agent must be adequate for reacting with a functional group containing active hydrogen such as the primary amino group, secondary amino group or a hydroxyl group to provide good cured coating. In general, the solid content weight ratio of the cationic resin to the blocked isocyanate curing agent is within a range of 90/10 to 50/50 and preferably 80/20 to 65/35.

For the defoaming agent used in the present invention, the content of the defoaming agent in the cationic electrodeposition coating composition is preferably used at an amount of 0.1 to 5 parts by weight based on 100 parts by weight of the cationic electrodeposition coating composition. When the content of the defoaming agent is 0.1 part by weight, there is fear that the defoaming property of the paint composition is inadequate and when it exceeds 5 parts by weight, there is fear that the anticorrosion property of coating is lowered.

When the pigment dispersion paste is contained, the amount is set as an amount in which the weight ratio (P/V) of the pigment contained in the paint composition to resin solid content is ½ or less and preferably ⅓ to 1/10. When P/V exceeds ½, the appearance of coating is inferior.

The paint composition can contain a tin compound such as dibutyltin dilaurate or dibutyltin oxide, a usual urethane cleavage catalyst, an organic solvent necessary for synthesizing a resin component and usually used additive for coating such as a plasticizer, an antioxidant, an ultraviolet absorbent and a pigment.

The cationic electrodeposition coating composition containing the defoaming agent of the present invention is coated on an article to be coated by electrodeposition by a method known to those skilled in the art and forms electrodeposition coating (uncured). Articles to be coated are not specifically limited so far as it is electroconductive, and for example, an iron plate, a steel plate, an aluminum plate, those on which surface treatment was carried out, molded articles thereof and the like can be mentioned.

The film thickness of the electrodeposition coating is preferably 10 to 20 μm. When the film thickness is less than 10 μm, the anticorrosion property is inadequate and when it exceeds 20 μm, it results in the loss of the paint. The electrodeposition coating obtained is as it is or rinsed with water after completion of electrodeposition process and then, is cured by baking at 120 to 260° C. and preferably 160 to 220° C. for 10 to 30 minutes.

### EXAMPLES

The present invention is further specifically illustrated below according to Examples but the present invention is not limited to these. In examples, “parts” and “%” are according to weight basis unless otherwise noted.

### Preparation Example 1

### Preparation of Amine Modified Epoxy Resin

In a flask equipped with a stirrer, a cooling tube, a nitrogen introducing tube, a thermometer and a dropping funnel, 92 parts of 2,4-/2,6-tolylenediisocyanate (weight ratio=8/2), 95 parts of methyl isobutyl ketone (hereinafter, abbreviated as MIBK) and 0.5 parts of dibutyltin dilaurate were charged. 21 Parts of methanol was added dropwise under stirring the reaction mixture. The reaction was started from room temperature and temperature was raised to 60° C. by exothermic heat. Then, after the reaction was continued for 30 minutes, 57 parts of ethyleneglycol mono-2-ethylhexyl ether was added dropwise from the dropping funnel. Further, 42 parts of the adduct of bisphenol A with 5 mol of propylene oxide was added to the reaction mixture. The reaction was mainly carried out in a range of 60 to 65° C. and continued until absorption based on the isocyanate group was disappeared in the measurement of IR spectrum.

Then, 365 parts of an epoxy resin having an epoxy equivalent of 188 which was synthesized from bisphenol A and epichlorohydrin by a known method was added to the reaction mixture and temperature was raised to 125° C. Then, 1.0 part of benzyldimethylamine was added and the mixture was reacted at 130° C. until the epoxy equivalent was 410.

Successively, when 61 parts of bisphenol A and 33 parts of octylic acid were added and reacted at 120° C., the epoxy equivalent was 1190. Then, the reaction mixture was cooled and 11 parts of diethanolamine, 24 parts of N-ethylethanolamine and 25 parts of the MIBK solution of 79% by weight of the ketimine converted product of aminoethylethanolamine were added to be reacted at 110° C. for 2 hours. Then, it was diluted with MIBK until nonvolatile content was 80% to obtain an epoxy resin containing an amine modified oxazolidine ring (the solid content of the resin: 80%)

### Preparation Example 2

### Preparation of Blocked Isocyanate Curing Agent

In a reaction container, 1250 parts of diphenylmethanediisocyante and 266.4 parts of MIBK were charged and after heating the mixture to 80° C., 2.5 parts of dibutyltin dilaurate was added. A solution in which 226 parts of ε-caprolactam was dissolved in 944 parts of butyl cellosolve was added dropwise to the mixture at 80° C. over 2 hours. Further, after heating it at 1000C for 4 hours, it was confirmed that absorption based on the isocyanate group was disappeared in the measurement of IR spectrum, and after standing to cool, 336.1 parts of MIBK was added to obtain a blocked isocyanate curing agent.

### Preparation Example 3

### Preparation of Pigment Dispersion Resin

Firstly, in a reaction container equipped with a stirring device, a cooling tube, a nitrogen introducing tube and a thermometer, 222.0 parts of isophoronediisocyanate (hereinafter, abbreviated as IPDI) was charged, it was diluted with 39.1 parts of MIBK and 0.2 parts of dibutyltin dilaurate was charged thereto. Then, after this was heated to 50° C., 131.5 parts of 2-ethylhexanol was added dropwise under stirring in dry nitrogen atmosphere over 2 hours. The reaction temperature was kept at 50° C. by appropriately cooling. As a result, IPDI half-blocked with 2-ethylhexanol (the solid content of the resin: 90.0%) was obtained.

Then, 87.2 parts of dimethylethanolamine, 117.6 parts of a 75% aqueous lactic acid solution and 39.2 parts of ethylene glycol monobutyl ether were added in order into an appropriate reaction container and the mixture was stirred at 65° C. for about 30 minutes to prepare a quaternary converting agent.

Then, 710.0 parts of EPON 829 (bisphenol A type epoxy resin manufactured by Shell Chemical Co., an epoxy equivalent of 193 to 203) and 289.6 parts of bisphenol A were charged in an appropriate reaction container, and the mixture was heated at 150 to 160° C. under nitrogen atmosphere to generate initial exothermic reaction. The reaction mixture was reacted at 150 to 160° C. for about 1 hour and then, after cooled to 120° C., 498.8 parts of the IPDI half-blocked with 2-ethylhexanol (MIBK solution) previously prepared was added.

The reaction mixture was kept at 110 to 120° C. for about 1 hour, then 463.4 parts of ethylene glycol monobutyl ether was added, the mixture was cooled to 85 to 95° C. to be homogenized, and 196.7 parts of the quaternary converting agent previously prepared was added. After keeping the reaction mixture at 85 to 95° C. until an acid value was 1, 964 parts of deionized water was added, and the quaternary conversion was completed in the epoxy-bisphenol A resin to obtain a resin for pigment dispersion having a quaternary ammonium salt portion (the solid content of the resin: 50%)

### Preparation Example 4

### Preparation of Pigment Dispersion Paste

In a sand grind mill, 120 parts of the resin for pigment dispersion obtained in the Production Example 3, 2.0 parts of carbon black, 100.0 parts of kaolin, 80.0 parts of titanium dioxide, 18.0 parts of aluminum phosphomolybdate and 221.7 parts of ion exchanged water were charged and dispersed until a particle size of 10 μm or less is obtained to obtain pigment dispersion paste (solid content: 48%).

### Preparation Example 5

### Preparation of Cationic Electrodeposition Coating Composition

The amine modified epoxy resin obtained in Production Example 1 and the blocked isocyanate curing agent obtained in the Production Example 2 were mixed at a solid content of 70/30 so as to be uniform. Glacial acetic acid was added thereto so that the milligram equivalent of acid per 100 g of the solid content of the resin was 35, and further, ion exchanged water was gradually added to be diluted. Emulsion with a solid content of 36% was obtained by removing MIBK under reduced pressure.

1500 Parts of the emulsion, 542 parts of the pigment dispersion paste obtained in Production Example 4, 1949 parts of the ion exchanged water and 9 parts of dibutyltin oxide were mixed to obtain a cationic electrodeposition coating composition with a solid content of 20% by weight.

### Preparation Example 6

Production was carried out by SAN NOPCO Ltd. according to the method below. In a pressure proof reactor which can carry out stirring, heating, cooling, dropwise addition, pressurization and pressure reduction, 342 parts (1 part by mol) of purified granulated sugar (manufactured by Taito Co., Ltd.) and 1000 parts of dimethylformamide (hereinafter, called as DMF) (manufactured by Mitsubishi Gas Chemical Co., Inc.) were charged and then operation (replacement with nitrogen) of pressurizing it until a gauge pressure reaches 4 MPa using nitrogen gas and discharging it until the pressure decreases to 0.2 MPa was repeated 3 times. Then, temperature was raised to 100° C. while stirring, then 696 parts (12 parts by mol) of PO was added dropwise over 6 hours at the same temperature and further, stirring was continued at the same temperature for 4 hours to react residual PO. Then, DMF was removed under reduced pressure of 100 to 10 mmHg at 120° C. and the adduct (S1)-of sucrose/12 mol of PO was obtained. Then, in a pressure proof reactor which can carry out stirring, heating, cooling, dropwise addition, pressurization and pressure reduction, 1038 parts (1 part by mol) of the adduct (S1) of sucrose/12 mol of PO and 6.0 parts of potassium hydroxide (special grade for reagent, hereinafter, the same) were added and water was removed at 130° C. for 1 hour under reduced pressure of 20 to 10 mmHg. Then, it was cooled to 110° C., 870 parts (15 parts by mol) of PO was added dropwise over 6 hours at the same temperature and further, it was kept at the same temperature for 4 hours to be reacted with residual PO. Then, 288 parts (4 parts by mol) of BO was added dropwise over 1 hour at the same temperature and further, it was kept at the same temperature for 1 hour to be reacted with residual BO. Then, after cooling to 90° C., 8.0 parts of ion exchanged water and 70 parts of KYOWARD 700 (alkali absorbent; the trade name of Kyowa Chemical Industry Co., Ltd.) were added to be stirred at 90° C. for 1 hour. The KYOWARD 700 was removed by carrying out filtration at the same temperature using a suction bottle, Nutsche, No.2 filter paper (manufactured by Toyo Roshi Kaisha Ltd.). Further, water was removed at 120° C. for 1 hour under reduced pressure of 100 to 10 mmHg to obtain the adduct of sucrose/27 mol of PO/4 mol of BO.

### Preparation Example 7

Preparation was carried out by SAN NOPCO Ltd. according to the method below. In a pressure proof reactor same as Production Example 6, 1038 parts (1 part by mol) of the adduct (Si) of sucrose/12 mol of PO and 9.5 parts of potassium hydroxide were added and water was removed at 130° C. for 1 hour under reduced pressure of 20 to 10 mmHg. Then, it was cooled to 110° C., 3074 parts (53 parts by mol) of PO was added dropwise over 12 hours at the same temperature and further, it was kept at the same temperature for 4 hours to be reacted with residual PO. Then, after cooling to 90° C., 8.0 parts of ion exchanged water and 70 parts of KYOWARD 700 (the trade name of Kyowa Chemical Industry Co., Ltd.) were added to be stirred at 90° C. for 1 hour. The KYOWARD 700 was removed by carrying out filtration at the same temperature using a suction bottle, Nutsche and No.2 filter paper (manufactured by Toyo Roshi Kaisha Ltd.). Further, water was removed at 120° C. for 1 hour under reduced pressure of 100 to 10 mmHg to obtain the adduct of sucrose/65 mol of PO.

### Example 1

In a pressure proof reactor which can carry out heating, cooling, stirring and sealing, 3 mol (6588 parts) of the adduct of sucrose/27 mol of PO/4 mol of BO obtained in the Production Example 6 was charged and water was removed at 100° C. for 1 hour under reduced pressure of 20 to 10 mmHg. Then, after cooling to 50° C., 1 mol (168 parts) of HDI was added and nitrogen replacement was repeated 3 times by the similar method to the Production Example 6. Then, temperature was raised to 120° C. for 1 hour while stirring, stirring was continued at the same temperature for 12 hours, and then the extinction of an isocyanate group was confirmed to obtain a polyoxyalkylene compound (A1). The coupling number per one molecule of the polyoxyalkylene compound (A) which is the average number of the number of the Q per one molecule of the polyoxyalkylene compound was 1.5 in average.

Thus, the polyoxyalkylene compound (A1) thus obtained by the production of SAN NOPCO Ltd. was used as a defoaming agent. A cationic electrodeposition coating composition containing the defoaming agent was obtained by mixing 100 parts of the cationic electrodeposition coating composition obtained in the Production Example 5 and 1.0 part of the above-mentioned defoaming agent (A1).

### Example 2

In a pressure proof reactor which can carry out heating, cooling, stirring and sealing, 5 mol (10980 parts) of the adduct of sucrose/27 mol of PO/4 mol of BO obtained in the Production Example 6 was charged and water was removed at 100° C. for 1 hour under reduced pressure of 20 to 10 mmHg. Then, after cooling to 50° C., 3 mol (504 parts) of HDI was added and nitrogen replacement was repeated 3 times by the similar method to the Production Example 6. Then, temperature was raised to 120° C. for 1 hour while stirring, stirring was continued at the same temperature for 12 hours, and then the extinction of an isocyanate group was confirmed to obtain a polyoxyalkylene compound (A2). The coupling number per one molecule of the polyoxyalkylene compound (A) which is the average number of the number of the Q per one molecule of the polyoxyalkylene compound was 2.5 in average.

Thus, the polyoxyalkylene compound (A2) thus obtained by the production of SAN NOPCO Ltd. was used as a defoaming agent. A cationic electrodeposition coating composition containing the defoaming agent was obtained by mixing 100 parts of the cationic electrodeposition coating composition obtained in the Production Example 5 and 1.0 part of the above-mentioned defoaming agent (A2).

### Example 3

In a pressure proof reactor which can carry out heating, cooling, stirring and sealing, 7 mol (15372 parts) of the adduct of sucrose/27 mol of PO/4 mol of BO obtained in the Production Example 6 was charged and water was removed at 100° C. for 1 hour under reduced pressure of 20 to 10 mmHg. Then, after cooling to 50° C., 5 mol (840 parts) of HDI was added and nitrogen replacement was repeated 3 times by the similar method to the Production Example 6. Then, temperature was raised to 120° C. for 1 hour while stirring, stirring was continued at the same temperature for 12 hours, and then the extinction of an isocyanate group was confirmed to obtain a polyoxyalkylene compound (A3). The coupling number per one molecule of the polyoxyalkylene compound (A) which is the average number of the number of the Q per one molecule of the polyoxyalkylene compound was 3.5 in average.

Thus, the polyoxyalkylene compound (A3) thus obtained by the production of SAN NOPCO Ltd. was used as a defoaming agent. A cationic electrodeposition coating composition containing the defoaming agent was obtained by mixing 100 parts of the cationic electrodeposition coating composition obtained in the Production Example 5 and 1.0 part of the above-mentioned defoaming agent (A3).

### Example 4

In a pressure proof reactor which can carry out heating, cooling, stirring and sealing, 5 mol (10980 parts) of the adduct of sucrose/27 mol of PO/4 mol of BO obtained in the Production Example 6 and 244.8 parts (6.1 parts by mol) of sodium hydroxide (special grade for reagent, manufactured by Wako Pure Chemical Industry Ltd., an amount converted to pure content excluding moisture and hereinafter, the same) were charged and water was removed at 120° C. for 1 hour under reduced pressure of 20 to 10 mmHg. Then, 255 parts (3 parts by mol) of dichloromethane (special grade for reagent, manufactured by Sigma-Aldrich Japan Co., Ltd. and hereinafter, abbreviated as Sigma Co.) was added dropwise at 80° C. over 1 hour while being under the same reduced pressure and sealing, further, stirring was continued at 100° C. for 1 hour, and it was cooled to 60° C. after confirming that the pressure of the reaction system reached completely at equilibrium to be separately taken in containers with a diameter of about 9 cm and a height of about 20 cm which were made of polyethylene.

After being left alone for one day, precipitates prepared were filtered at room temperature (about 25° C.) using a No.2 filter paper (manufactured by Toyo Roshi Kaisha Ltd., and hereinafter, the same), 10 parts of ion exchange water was added to 500 parts among the crude reaction liquid product obtained and heated to 90° C. while stirring and then, 30 parts of KYOWARD 700 (manufactured by Kyowa Chemical Industry Co., Ltd. and hereinafter, the same) was added to be stirred at the same temperature for 1 hour. Then, the KYOWARD 700 was removed by carrying out filtration at the same temperature using the No.2 filter paper. Further, water was removed at 120° C. for 1 hour under reduced pressure of 20 to 10 mmHg (hereinafter, removal of sodium hydroxide and removal of water with these KYOWARD 700 are abbreviated as KYOWARD treatment) to obtain the polyoxyalkylene compound (A4). The coupling number per one molecule of the polyoxyalkylene compound (A) which is the average number of the number of the Q per one molecule of the polyoxyalkylene compound was 2.5 in average.

Thus, the polyoxyalkylene compound (A4) thus obtained by the production of SAN NOPCO Ltd. was used as a defoaming agent. A cationic electrodeposition coating composition containing the defoaming agent was obtained by mixing 100 parts of the cationic electrodeposition coating composition obtained in the Production Example 5 and 1.0 part of the above-mentioned defoaming agent (A4).

### Example 5

In a pressure proof reactor which can carry out heating, cooling, stirring and sealing, 5 mol (20560 parts) of the adduct of sucrose/65 mol of PO obtained in Production Example 7 was charged and water was removed at 100° C. for 1 hour under reduced pressure of 20 to 10 mmHg. Then, after cooling to 50° C., 3 mol (504 parts) of HDI was added and nitrogen replacement was repeated 3 times by the similar method to the Production Example 6. Then, temperature was raised to 120° C. for 1 hour while stirring, stirring was continued at the same temperature for 12 hours, and then the extinction of an isocyanate group was confirmed to obtain a polyoxyalkylene compound (A5). The coupling number per one mole of the polyoxyalkylene compound (A) which is the average number of the number of the Q per one molecule of the polyoxyalkylene compound was 2.5 in average.

Thus, the polyoxyalkylene compound (AS) thus obtained by the production of SAN NOPCO Ltd. was used as a defoaming-agent. A cationic electrodeposition coating composition containing the defoaming agent was obtained by mixing 100 parts of the cationic electrodeposition coating composition obtained in the Production Example 5 and 1.0 part of the above-mentioned defoaming agent (A5).

### Example 6

In a pressure proof reactor which can carry out heating, cooling, stirring and sealing, 5 mol (10980 parts) of the adduct of sucrose/27 mol of PO/4 mol of BO obtained in the Production Example 6 was charged and water was removed at 100° C. for 1 hour under reduced pressure of 20 to 10 mmHg. Then, after cooling to 50° C., 3 mol (504 parts) of HDI was added and nitrogen replacement was repeated 3 times by the similar method to the Production Example 6. Then, temperature was raised to 120° C. for 1 hour while stirring, stirring was continued at the same temperature for 12 hours, and then the extinction of an isocyanate group was confirmed to obtain a polyoxyalkylene compound (A6). The coupling number per one molecule of the polyoxyalkylene compound (A) which is the average number of the number of the Q per one molecule of the polyoxyalkylene compound was 2.5 in average.

Thus, the polyoxyalkylene compound (A6) thus obtained by the production of SAN NOPCO Ltd. was used as a defoaming agent. A cationic electrodeposition coating composition containing the defoaming agent was obtained by mixing 100 parts of the cationic electrodeposition coating composition obtained in the Production Example 5 and 3.0 parts of the above-mentioned defoaming agent (A6).

### Comparative Example 1

The cationic electrodeposition coating composition obtained in Production Example 5 was used without adding a defoaming agent as it was.

### Comparative Example 2

A cationic electrodeposition coating composition was obtained by mixing 100 parts of the cationic electrodeposition coating composition obtained in Production Example 5 with 1.0 part by weight of the adduct of sucrose/27 mol of PO/4 mol of BO obtained in the Production Example 6.

### Comparative Example 3

A cationic electrodeposition coating composition was obtained by mixing 100 parts of the cationic electrodeposition coating composition obtained in Production Example 5 with 1.0 part by weight of the adduct of sucrose/65 mol of PO obtained in the Production Example 7.

### Comparative Example 4

A cationic electrodeposition coating composition was obtained by mixing 100 parts of the cationic electrodeposition coating composition obtained in preparation Example 5 with 3.0 parts by weight of the adduct of sucrose/27 mol of PO/4 mol of BO obtained in the Production Example 6.

The under-mentioned evaluation test was carried out with respect to the cationic electrodeposition coating compositions obtained by the above-mentioned Examples and Comparative Examples.

Defoaming Property Test

The cationic electrodeposition coating compositions obtained by Examples and Comparative Examples were stirred for 10 minutes at 1500 rpm using a stirrer and these were charged in Ford cups #4. The bottom face of the Ford cups in which the paint compositions were charged was provided at a height of 1 m from a floor and then, the paint composition was dropped in a 500 ml measuring cylinder from the Ford cup. The volume (ml) of foams just after dropping was measured.

Then, the foams generated in the 500 ml measuring cylinder was gradually deformed since all of the paint composition in the Ford cup was dropped, time was measured until the liquid surface of the paint composition could be visually confirmed at the central potion of the liquid surface when it was viewed from the upside of the measuring cylinder, and the time was referred to as the defoaming time. The result obtained is shown in Tables 1 and 2.

Unevenness of Drying

A zinc phosphate processed steel plate (JIS G 3141 SPCC-SD; treatment was carried out using THUNDER FIN SD-2500 (manufactured by Nippon Paint Co., Ltd.), dimension; 70 mm×150 mm, thickness; 0.7 mm) was immersed 10 cm below in an electrodeposition bath containing the cationic electrodeposition coating composition. Voltage was applied to the plate and pressurization was carried out at a voltage of 200 V over 30 seconds to carry out electrodeposition coating for 150 seconds. After the electrodeposition coating, the plate was pulled up from the electrodeposition bath in the stainless container and dried naturally for 180 seconds in a state in which the plate was pulled up. Then, the plate was rinsed with water and the evaluation sample was prepared by curing it by heating at 170° C. for 25 minutes. The appearance of the sample obtained was visually evaluated according to the under-mentioned basis. The result obtained is shown in Tables 1 and 2.
oo: The unevenness of drying was not generated at all.
o: The unevenness of drying was slightly generated but it was not a level being a problem.
oΔ: The unevenness of drying was generated.
Δ: The unevenness of drying was dominantly generated.

x: The unevenness of drying was remarkably generated.

TABLE 1

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Average | 1.5 | 2.5 | 3.5 | 2.5 | 2.5 | 2.5 |
| coupling | | | | | | |
| number per | | | | | | |
| molecule | | | | | | |
| Content of | 1.0 | 1.0 | 1.0 | 1.0 | 1.0 | 3.0 |
| polyoxy- | | | | | | |
| alkylene | | | | | | |
| compound (A) | | | | | | |
| Foaming | 125 | 105 | 95 | 95 | 105 | 80 |
| amount (ml) | | | | | | |
| Defoaming | 27 | 17 | 16 | 16 | 18 | 13 |
| time (min) | | | | | | |
| Unevenness of | ∘ | ∘∘ | ∘∘ | ∘∘ | ∘∘ | ∘∘ |
| drying | | | | | | |

TABLE 2

| | Compara- | Compara- | Compara- | Compara- |
|---|---|---|---|---|
| | tive | tive | tive | tive |
| | Example | Example | Example | Example |
| | 1 | 2 | 3 | 4 |
| Average coupling | — | — | — | — |
| number per | | | | |
| molecule | | | | |
| Content | — | 1.0 | 1.0 | 3.0 |
| Foaming amount | 210 | 125 | 115 | 100 |
| (ml) | | | | |
| Defoaming time | 48 | 28 | 23 | 16 |
| (minute) | | | | |
| Unevenness of | ∘∘ | ∘Δ | Δ | Δ |
| drying | | | | |

Any of the cationic electrodeposition coating compositions of Examples was excellent in defoaming property and also unevennes of drying property. On the other hand, that of Comparative Example 1 without adding a defoaming agent was much in foaming amount and also long in defoaming time. Although those of Comparative Examples 2 to 4 containing the defoaming agent with no coupling structure were superior in defoaming property, the lowering of unevennes of drying property was confirmed.

1. A cationic electrodeposition coating composition comprising a binder resin containing a cationic epoxy resin and a block isocyanate curing agent and a defoaming agent, wherein the defoaming agent contains at least one of polyoxyalkylene compounds (A) represented by any one of the following formulae (1) to (3):
]R—(OA)ₙ₁]ₜ₋ₘQ[—(OA)ₙ₂-L]ₘ (1)
[R—(OA)ₙ₁]ₜ₋ₘQ[—(OA)ₙ₂-L-(OA)ₙ₃-Q[—(OA)ₙ₄-R]_{t-1]}ₘ (2)
[R—(OA)ₙ₁]ₜ₋₁Q-L-Q [—(OA)ₙ₂-L]ₜ₋₁ (3)
wherein Q is a reaction residual group formed by removing a hydrogen atom(s) from a number t of primary hydroxyl groups of nonreducing disaccharide or trisaccharide,
L is the reaction residual group of isocyanate or the reaction residual group of dihalogenated alkyl,
OA is an oxyalkylene group having a carbon number of 2 to 4,
each of n1 to n4 is independently an integer of 2 to 40,
t is an integer of 2 to 4 and
m is an integer of 1 to 3 and smaller than t, but provided that the total number of OA's in a molecule is 10 to 80 per one of Q.

2. The cationic electrodeposition coating composition according to claim 1, wherein the Q is a reaction residual group formed by removing a hydrogen atom(s) from the 3 primary hydroxyl groups of sucrose.

3. The cationic electrodeposition coating composition according to claim 1, wherein a coupling number per one molecule of the polyoxyalkylene compounds (A) is 1.5 to 5 in average.

4. The cationic electrodeposition coating composition according to claim 1, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.1 to 0.8 parts by mol of isocyanate (a3-1).

5. The cationic electrodeposition coating composition according to claim 1, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.2 to 0.9 parts by mol of dihalogenated hydrocarbon having a carbon number of 1 to 4 (a3-21).

6. The cationic electrodeposition coating composition according to claim 1, wherein the content of the polyoxyalkylene compounds (A) is 0.1 to 5 parts by weight based on 100 parts by weight of the cationic electrodeposition coating composition.

7. A method for suppressing the foaming of an electrodeposition bath, comprising a step of containing a defoaming agent containing at least one of the polyoxyalkylene compounds (A) represented by any one of the following formulae (1) to (3) so as to be 0.1 to 5 parts by weight based on 100 parts by weight of the cationic electrodeposition coating composition, in the cationic electrodeposition coating composition comprising a binder resin containing a cationic epoxy resin and a block isocyanate curing agent:
]R—(OA)ₙ₁]ₜ₋ₘQ[—(OA)ₙ₂-L]ₘ (1)
[R—(OA)ₙ₁]ₜ₋ₘQ[—(OA)ₙ₂-L-(OA)ₙ₃-Q[—(OA)ₙ₄-R]_{t-1]}ₘ (2)
[R—(OA)ₙ₁]ₜ₋₁Q-L-Q [—(OA)ₙ₂-L]ₜ₋₁ (3)
wherein Q is a reaction residual group formed by removing a hydrogen atom(s) from the t of primary hydroxyl groups of nonreducing disaccharide or trisaccharide,
L is the reaction residual group of isocyanate or the reaction residual group of dihalogenated alkyl,
OA is an oxyalkylene group having a carbon number of 2 to 4,
each of n1 to n4 is independently an integer of2 to 40,
t is an integer of 2 to 4 and
m is an integer of 1 to 3 and smaller than t, but provided that the total number of OA's in a molecule is 10 to 80 per one of Q.

8. The cationic electrodeposition coating composition according to claim 2, wherein a coupling number per one molecule of the polyoxyalkylene compounds (A) is 1.5 to 5 in average.

9. The cationic electrodeposition coating composition according to claim 2, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.1 to 0.8 parts by mol of isocyanate (a3-1).

10. The cationic electrodeposition coating composition according to claim 3, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.1 to 0.8 parts by mol of isocyanate (a3-1).

11. The cationic electrodeposition coating composition according to claim 2, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.2 to 0.9 parts by mol of dihalogenated hydrocarbon having a carbon number of 1 to 4 (a3-21).

12. The cationic electrodeposition coating composition according to claim 3, wherein the polyoxyalkylene compounds (A) is produced by the chemical reaction of 1 part by mol of nonreducing disaccharide or trisaccharide (a1), 10 to 80 parts by mol of alkylene oxide having a carbon number of 2 to 4 (a2) and 0.2 to 0.9 parts by mol of dihalogenated hydrocarbon having a carbon number of 1 to 4 (a3-21).

13. The cationic electrodeposition coating composition according to claim 2, wherein the content of the polyoxyalkylene compounds (A) is 0.1 to 5 parts by weight based on 100 parts by weight of the cationic electrodeposition coating composition.

14. The cationic electrodeposition coating composition according to claim 3, wherein the content of the polyoxyalkylene compounds (A) is 0.1 to 5 parts by weight based on 100 parts by weight of the cationic electrodeposition coating composition.

15. The cationic electrodeposition coating composition according to claim 4, wherein the content of the polyoxyalkylene compounds (A) is 0.1 to 5 parts by weight based on 100 parts by weight of the cationic electrodeposition coating composition.

16. The cationic electrodeposition coating composition according to claim 5, wherein the content of the polyoxyalkylene compounds (A) is 0.1 to 5 parts by weight based on 100 parts by weight of the cationic electrodeposition coating composition.
